(19) United States
(12) Patent Application Publication
(10) Pub. No.: US 2026/0148505 A1
(43) Pub. Date: May 28, 2026

(54) SYSTEMS AND METHODS FOR SELECTING AND CONTROLLING OBJECTS TO RETRIEVE INFORMATION AND MANAGE FUNCTIONALITIES BASED ON USER ORIENTATION AND INPUT ATTRIBUTES

(71) Applicant: Adeia Guides Inc., San Jose, CA (US)

(72) Inventors: Evgeny Kaminsky, Hollywood, FL (US); Reda Harb, Saint Petersburg, FL (US); Dhananjay Lal, Englewood, CO (US)

(21) Appl. No.: 18/960,625

(22) Filed: Nov. 26, 2024

(51) Int. Cl. G06T 19/00

(52) U.S. Cl. CPC G06T 19/006

(57) ABSTRACT

Systems and methods are provided herein for displaying control elements for devices based on user inputs and/or past user interactions. This may be accomplished by a system detecting a first input (e.g., voice query) and then calculating a field of view of a user when the first input was detected. The system may use both a first attribute associated with the first input and the field of view of the user to identify a first device of a plurality of devices. The system may then identify an action corresponding to the first device and the first attribute. A display element related to the action is retrieved and then displayed for the user. The system may then cause the first device to perform the action upon a user selection of the display element.

### BACKGROUND

The present disclosure relates to techniques for controlling smart devices based on one or more user inputs.

### SUMMARY

With the proliferation of smart devices, consumers now have access to a wide range of interconnected devices that can enhance daily life by automating tasks, offering remote control options, and/or providing valuable insights through data. These devices (e.g., thermostats, lights, speakers, televisions, smartphones, laptops, and/or similar such devices) often feature advanced capabilities and functionalities, which has increased adoption. As these devices have evolved to include more complex and comprehensive features, they have also introduced new inefficiencies related to user interactions.

The user interfaces of many of these devices may be intricate, requiring users to navigate thought various screens, menus, and/or settings to perform a desired action. The user interfaces may also require a user to perform multiple steps or actions to a complete a single task. For example, adjusting a smart thermostat may require a user opening an application, selecting the correct device, and configuring the temperature. In another example, activating a light in a smart home may involve opening an application, locating the correct room, selecting a configuration, and confirming the selection. Both examples may frustrate the user because the multiple actions take more time than desired. Further, if the user wants to take multiple actions (e.g., adjust thermostat, activate light, and start music) this problem is exacerbated.

Users may spend considerable time learning device functionalities, completing repetitive tasks, and/or navigating lengthy sequences of actions when interacting with the smart devices. As the number of devices in a typical household grows, the cumulative time spent managing these devices becomes more significant, impacting the overall user experience and diminishing the intended benefits of automation and ease.

Accordingly, techniques are disclosed herein for displaying control elements for devices based on the gaze and/or past behavior of a user. For example, a system may detect a first input. The first input may be a voice command, gesture, gaze, and/or similar such input. The system may use a first device comprising one or more sensors to detect the first input. The first device may also detect an orientation of the user when the first input is detected. For example, the user may be wearing an extended reality (XR) device (e.g., Apple Vision Pro (AVP), Meta Quest Virtual Reality Headset, etc.) and the XR device detects the orientation of the user's head when the first input is detected. In another example, the first device may use one or more image detection models to process images of the user captured by one or more cameras and determine the orientation of the user's head. The first device may then calculate a field of view of the user based on the orientation of the user.

The system may also identify a plurality of devices connected to a network. In some embodiments, this network is the user's home network, and the plurality of devices are smart devices connected to the home network. The system may select a set of devices of the plurality of devices connected to the network based, at least in part, on each device of the set of devices being associated with the first input. For example, the first input may be a voice command of “increase brightness,” and the set of devices may comprise a television, a smartphone, and a light because the television, the smartphone, and the light all have adjustable brightness settings. The system may then select a subset of the set of devices based, at least in part, on each device of the subset of devices being located within the first field of view. For example, the first field of view of the user may be a first room. The system may select the television and the light because the television and the light are in the first room and the system may not select the smartphone because the smartphone is in a second room outside the first field of view.

The system may then identify and/or generate display elements associated with one or more devices of the subset of devices. The display elements may relate to the first input. For example, if the first input is a voice command of “increase brightness,” then the display element may be a brightness setting control for the television. The display elements may also comprise status information. For example, if the first input is a voice command of “increase brightness,” then the display element may be a brightness setting control for the television that shows the current brightness settings. The system may display the display element for the user. For example, the system may display a brightness setting control for the television on an XR device worn by the user. In some embodiments, the system may display more than one display element. For example, the system may display a first display element (e.g. brightness setting control for the television) and a second display element (e.g., brightness setting control for the light) on an XR device worn by the user. Accordingly, in response to a user input, the system identifies devices based on one or more attributes of the user input and one or more attributes of the devices.

The system may also group devices according to past user interactions to facilitate predicting a user's intentions. In some embodiments, the system may identify a first device based on a first input. For example, the first device may be a smartphone, and the system identifies the first device when the user selects a fitness application on the smartphone. The system may also identify a first set of attributes associated with the smartphone and/or the fitness application. For example, the first set of attributes may comprise brightness, health, notification, media sharing, and/or similar such attributes. The system may also identify a second device based on a second input. For example, the second device may be a thermostat, and the system identifies the second device when the user gazes at the thermostat. The system may also identify a second set of attributes associated with the thermostat. For example, the second set of attributes may comprise comfort, health, energy, and/or similar such attributes.

If one or more attributes of the second set of attributes match the first set of attributes, then the system may identify one or more actions. For example, the system may determine that the second set of attributes and the first set of attributes both comprise “health.” Since the second set of attributes and the first set of attributes both comprise “health,” the system may determine one or more actions (e.g., turning on the air conditioning or adjusting the temperature) related to the second device (e.g., thermostat). The system may then cause the second device (e.g., thermostat) to perform the one or more actions (e.g., turning on the air conditioning). The system may automatically cause the second device to perform the one or more actions based, at least in part, on the second input and past user interactions. For example, the system may determine that the user consistently uses the thermostat to turn on the air conditioning while the user is using the fitness application on the smartphone. Accordingly, when a user selects the fitness application on the smartphone and gazes at the thermostat, the system may automatically turn on the air conditioning based on the past user interactions.

In some embodiments, the system also displays one or more display elements related to the one or more actions. For example, an XR device worn by the user may display a temperature control display in response to the user selecting the fitness application on the smartphone and gazing at the thermostat. In some embodiments, none of the past user interactions associate the first device with the second device. For example, it may be the first time that the user uses the fitness application on the smartphone and gazes at the thermostat. In such an example, the system may display one or more display elements (e.g., temperature control display) based on one or more attributes (e.g., health) of the second device (e.g., thermostat) matching one or more attributes (e.g., health) of the first device (e.g., smartphone).

In some embodiments, the system also surfaces applications based on one or more user inputs. For example, the system may receive a voice query (e.g., “open fitness application”). The system may identify a first application (e.g., fitness application) in response to the voice query. The system may then identify a plurality of applications that share one or more attributes with the first application. For example, the first application (e.g., fitness application) may be associated with a first attribute (e.g., health). The system may identify a second application (e.g., music playlist application) and a third application (e.g., thermostat application) because the second application (e.g., music playlist application) and the third application (e.g., thermostat application) are also associated with the first attribute (e.g., health). The system may then issue a first prompt to the second application and the third application. The first prompt may indicate that an input related to the first attribute (e.g., health) is detected. The second application may then issue a second prompt indicating a first action (e.g., play a workout playlist). The system may then cause a notification to be displayed, wherein the notification corresponds to the first action. For example, the system may display a first notification (e.g., “Do you want me to start playing your workout playlist?”). In response to the user selecting the first notification, the system may cause the second application (e.g., music playlist application) to perform the first action (e.g., play a workout playlist).

### BRIEF DESCRIPTION OF THE DRAWINGS

The present disclosure, in accordance with one or more various embodiments, is described in detail with reference to the following figures. The drawings are provided for purposes of illustration only and merely depict typical or example embodiments. These drawings are provided to facilitate an understanding of the concepts disclosed herein and should not be considered limiting of the breadth, scope, or applicability of these concepts. It should be noted that for clarity and ease of illustration, these drawings are not necessarily made to scale.

FIG. 1 shows an illustrative diagram of a system for displaying control elements for devices based on one or more inputs, in accordance with some embodiments of the disclosure.

FIGS. 2A-2B show a device displaying one or more display elements, in accordance with some embodiments of the disclosure.

FIG. 3 shows another illustrative diagram of a system for displaying control elements for devices based on one or more inputs, in accordance with some embodiments of the disclosure.

FIG. 4 shows another illustrative diagram of a system for displaying control elements for devices based on one or more inputs, in accordance with some embodiments of the disclosure.

FIG. 5 shows another illustrative diagram of a system for displaying control elements for devices based on one or more inputs, in accordance with some embodiments of the disclosure.

FIG. 6 shows an illustrative block diagram of a system, in accordance with embodiments of the disclosure.

FIG. 7 shows an illustrative block diagram of a media system, in accordance with embodiments of the disclosure.

FIG. 8 shows an illustrative block diagram of a user equipment device system, in accordance with some embodiments of the disclosure.

FIG. 9 is an illustrative flowchart of a process for displaying control elements for devices based on one or more inputs, in accordance with some embodiments of the disclosure.

FIG. 10 is another illustrative flowchart of a process for displaying control elements for devices based on one or more inputs, in accordance with some embodiments of the disclosure.

FIG. 11 is an illustrative flowchart of a process for displaying notifications based on one or more inputs, in accordance with some embodiments of the disclosure.

### DETAILED DESCRIPTION

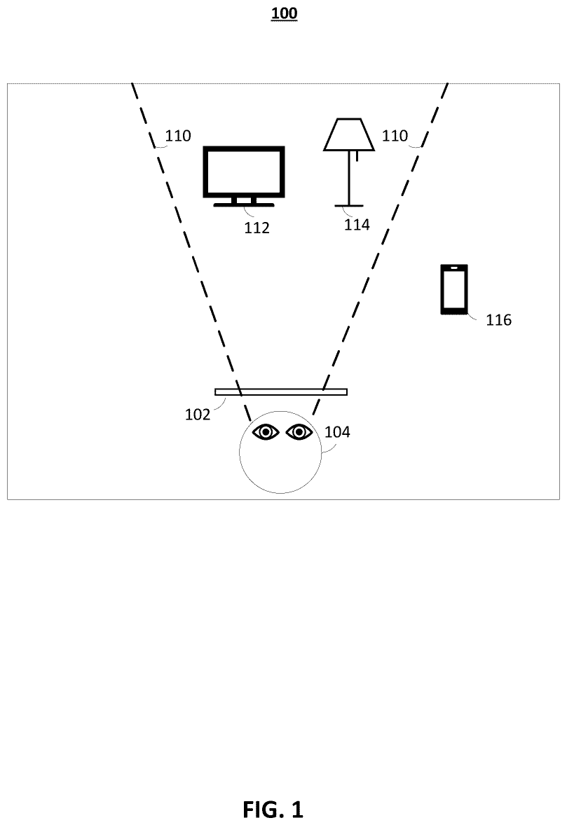

FIG. 1 shows an illustrative diagram of a system 100 for displaying control elements for devices based on one or more inputs, in accordance with some embodiments of the disclosure. System 100 includes a user 104 interacting with a first device 102. In some embodiments, the first device 102 is an XR device worn by the user 104. In some embodiments, the first device 102 is a smart watch, smartphone, laptop, and/or similar such devices. The system 100 may also include a second device 112, a third device 114, and a fourth device 116. Although four devices are shown, any number of devices may be used. For example, there may be more or less devices than shown.

The system 100 may identify a plurality of devices connected to a network. In some embodiments, the network is a home network, and the plurality of devices are smart devices connected to the home network. The system 100 may identify each device of the plurality of devices using one or more registration processes. During the registration process the system 100 may receive device information. The system 100 may use the device information to determine attributes corresponding to each device. For example, the second device 112 may be associated with a first set of attributes (e.g., brightness, volume, media sharing, and/or similar such attributes) and the third device 114 may be associated with a second attribute (e.g., brightness). The system 100 may store the attributes associated with each device in one or more profiles. In some embodiments, a control hub (e.g., control hub 614) stores the device information and/or attributes associated with the plurality of devices. In some embodiments, the devices communicate with each other and/or with a control hub using one or more wired and/or wireless communication protocols. For example, the first device 102, the second device 112, the third device 114, and the fourth device 116 may communicate via a Wi-Fi network.

In some embodiments, the system 100 detects a first input. The first input may be a voice query, gesture, gaze, and/or similar such input. For example, a first input may be a voice query (e.g., “increase brightness”) uttered by the user 104. In another example, the first input may be a tap of a touch display of the first device 102. In another example, the first input may be the user 104 gazing at the second device 112. In another example, the first input may be the user 104 pointing at the second device 112 with their hand/fingers. In another example, the first input may be the user 104 blinking and/or moving their eyes. The system 100 may use one or more sensors to detect the first input. The one or more sensors may include a camera, depth sensor, Lidar sensor, location sensor, pressure sensor, accelerometer, audio sensor, and/or similar such sensors.

In some embodiments, the first device 102 comprises the one or more sensors used to detect the first input. For example, the first device 102 may comprise a microphone that detects a voice query (e.g., “increase brightness”) uttered by the user 104. In some embodiments, one or more other devices comprise the one or more sensors used to detect the first input. For example, the second device 112 may comprise a camera that detects a gesture made by the user 104.

In some embodiments, the system 100 also detects an orientation of the user 104 when the first input is detected. For example, the first device 102 may be an XR device worn by the user 104 and the first device 102 detects the orientation of the user's head when the first input is detected. In another example, the one or more devices may use one or more image detection models to process images of the user 104 captured by one or more cameras and determine the orientation of the head of the user 104. In another example, the one or more devices may use one or more image detection models to process images of the user 104 captured by one or more cameras and determine the location of one or more eyes and/or pupils of the user 104. The system 100 may then calculate a field of view 110 of the user 104 based on the orientation of the user 104. In some embodiments, the system 100 uses any of the sensors described herein to detect and/or to determine the field of view 110 of the user 104.

In response to the first input, the system 100 may identify one or more devices of the devices connected to the network based, at least in part, on the one or more devices being associated with the first input. In some embodiments, the system 100 uses one or more attributes of the devices to determine one or more devices associated with the first input. For example, the first input may be a voice query of “increase brightness,” and the set of devices may comprise the second device 112, the third device 114, and the fourth device 116 because the second device 112, the third device 114, and the fourth device 116 all have adjustable brightness settings. In another example, the first input may be a voice query of “decrease volume,” and the set of devices may comprise the second device 112 and the fourth device 116 because the second device 112 and the fourth device 116 have adjustable volumes.

The system 100 may select a subset of the devices associated with the first input based, at least in part, on each device of the subset of devices being located within the field of view 110 of the user 104. For example, the first input may be a voice query of “increase brightness,” and the set of devices may comprise the second device 112, the third device 114, and the fourth device 116 because the second device 112, the third device 114, and the fourth device 116 all have adjustable brightness settings. The system 100 may select the second device 112 and the third device 114 as the subset of devices because the second device 112 and the third device 114 are within the field of view 110 of the user 104. In some embodiments, the system 100 selects a single device of the devices associated with the first input based, at least in part, on the single device being located within the first field of view. For example, the first input may be a voice query of “decrease volume,” and the set of devices may comprise the second device 112 and the fourth device 116 because the second device 112 and the fourth device 116 have adjustable volumes. The system may select the second device 112 as the single device because the second device 112 is associated with the first input and is within the field of view 110 of the user 104.

In some embodiments, the system 100 uses one or more additional inputs to confirm one or more identified devices. For example, the first input may be the user 104 gazing at a media file displayed on the fourth device 116. The fourth device 116 may highlight the media file in response to the first input. The system 100 may receive an additional input when the user 104 does a hand gesture (e.g., pinch, swipe, thumbs up, point, etc.). The system 100 may use the additional input as a confirmation that the media file is selected by the user. The system 100 may then receive a voice query identifying the second device 112 (e.g., “send to the TV”). The system 100 may then transfer the selected media file to the second device 112 in response to the voice query. In some embodiments, the system 100 reformats the media file for optimal display on the second device 112.

The system 100 may identify one or more display elements for the subset of devices. The display elements may relate to one or more actions of the devices. For example, the display elements may relate to brightness setting controls, temperature setting controls, volume setting controls, media output controls, media transfer controls, activation controls, and/or similar such controls. In some embodiments, the one or more display elements relate to the first input. For example, if the first input is a voice command of “increase brightness,” and the subset of devices comprises the second device 112 and the third device 114, then a display element may be a brightness setting control for the second device 112 and/or the third device 114. In some embodiments, the system 100 stores the display elements in one or more profiles. For example, a control hub may store one or more display elements during the device registration process. In some embodiments, the system 100 receives the display elements from one or more devices. For example, the system 100 may request a first display element related to the first input from the second device 112, and may request a second display element related to the first input from the third device 114. The second device 112 may transmit the first display element to the first device 102 for display and the third device 114 may transmit the second display element to the first device 102 for display.

In some embodiments, one or more devices display the one or more identified display elements for the user. For example, if the first input is a voice command of “increase brightness,” then the device may identify a first display element related to brightness setting controls for the second device 112. The first device 102 may then display the brightness setting controls for the second device 112 on the display of the first device 102. In some embodiments, the system may display more than one display element. For example, if the first input is a voice command of “increase brightness,” then the device may identify a first display element related to brightness setting controls for the second device 112 and a second display element related to brightness setting controls for the third device 114. The first device 102 may then display the brightness setting controls for the second device 112 and the brightness setting controls for the third device 114 on the display of the first device 102.

The display elements may be selectable by the user 104. For example, the first device 102 may display a display element associated with the brightness setting controls for the third device 114. The user 104 may select the display element to adjust the brightness settings of the third device 114. In another example, the first device 102 may display a display element associated with the volume setting controls for the second device 112. The user 104 may select the display element to adjust the volume settings of the second device 112.

The system 100 may cause one or more devices to perform an action in response to the selection of the user 104. For example, if the selection of the user 104 corresponds to decreasing the brightness of the third device 114, then the first device 102 may send a request to the third device 114 to decrease the brightness settings according to the selection of the user 104. In another example, if the selection of the user 104 corresponds to decreasing the brightness of the third device 114, then the first device 102 may send a first request to a control hub. The control hub may then send a second request to the third device 114 to decrease the brightness settings according to the selection of the user 104.

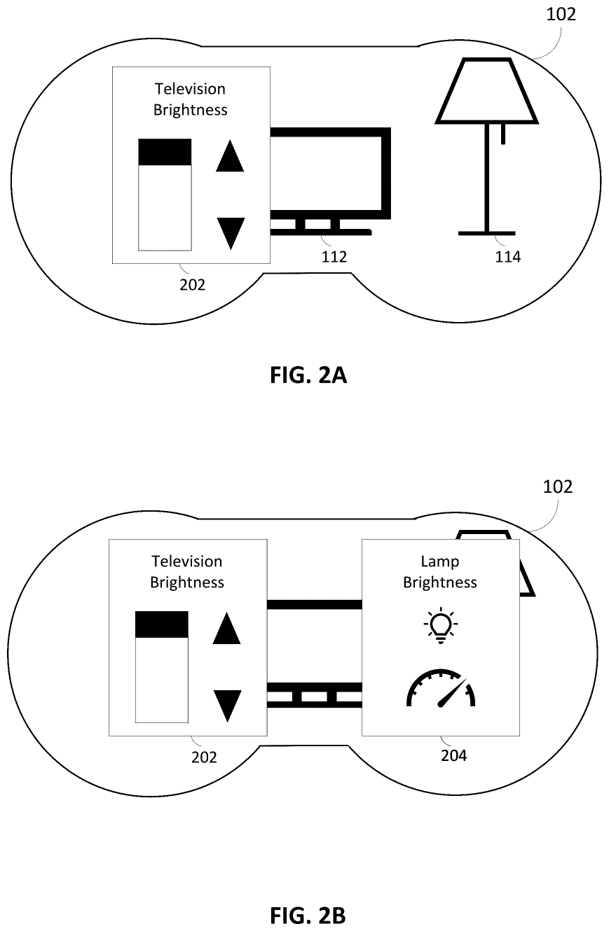

FIGS. 2A-2B show a device displaying one or more display elements, in accordance with some embodiments of the disclosure. In some embodiments, the device is the first device 102 from FIG. 1. Although the first device 102 is displayed as an XR device, other devices may display the one or more display elements. For example, the first device 102 may be a smart watch, smartphone, laptop, and/or similar such devices.

In some embodiments, the first device 102 displays one or more identified display elements for the user. For example, in response to a voice command of “increase brightness,” the first device 102 may identify a first display element 202 related to brightness setting controls for the second device 112. The first device 102 may then display the first display element 202 related to brightness setting controls for the second device 112 as displayed in FIG. 2A. In another example, in response to a voice command of “increase brightness,” the first device 102 may identify a first display element 202 related to brightness setting controls for the second device 112 and a second display element 204 related to brightness setting controls for the third device 114. The first device 102 may then display the first display element 202 and the second display element 204 as displayed in FIG. 2B.

In some embodiments, the display elements may be selectable. In some embodiments the display elements comprise one or more selectable options. A user may interact with one or more display elements using a voice query, gesture, gaze, and/or similar such input. For example, a user selection may be a voice query associated with the first display element 202. In another example, a user selection may be a tap of a touch display of the first device 102. In another example, the user selection may be the user gazing at the first display element 202. In another example, the user selection may be the user making a gesture with their hand. In another example, the user selection may be the user blinking and/or moving their eyes. The system 100 may use any of the sensors described herein to detect the selection.

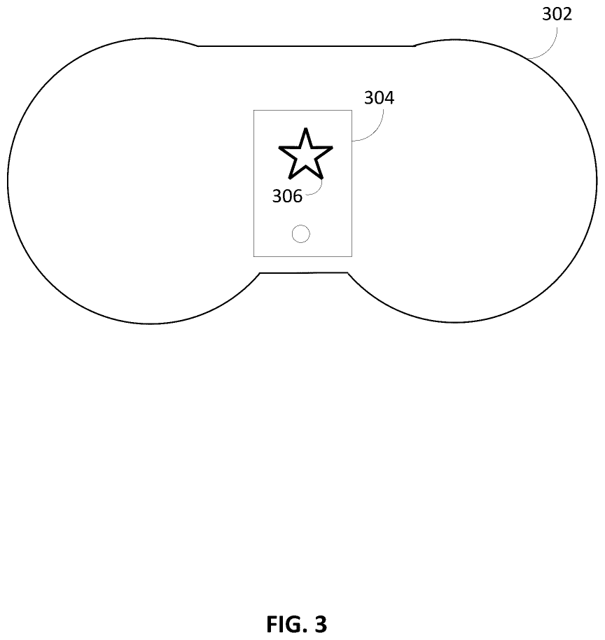

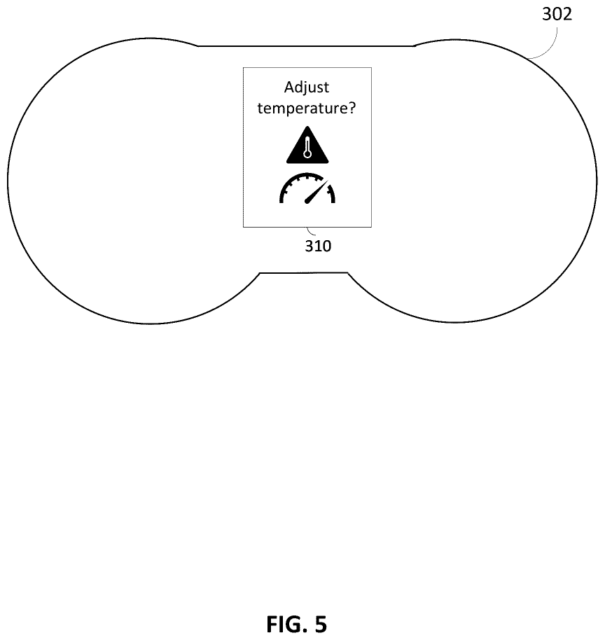

FIG. 3 shows another illustrative diagram of a system for displaying control elements for devices based on one or more inputs, in accordance with some embodiments of the disclosure. FIG. 3 shows an XR device 302. In some embodiments, the XR device 302 is the first device 102 from FIG. 1. Although the XR device 302 is shown, other devices may practice the methodologies describe herein. For example, the methodologies described may be performed with a smart watch, smartphone, laptop, and/or similar such devices. One of more functions described in relation to FIGS. 3-5 are described as being performed by the XR device 302. Although the one of more functions are described as being performed by the XR device 302, in some embodiments, one or more other device in the system may perform said functions.

In some embodiments, the XR device 302 detects a first input. The first input may be a voice query, gesture, gaze, and/or similar such input. For example, the XR device 302 may detect a first input when the user gazes at a first device 304. In another example, the XR device 302 may detect a first input when the user launches an application 306 on the first device 304. The XR device 302 may use one or more sensors to detect the first input. The one or more sensors may include a camera, depth sensor, Lidar sensor, location sensor, pressure sensor, accelerometer, audio sensor, and/or similar such sensors. In some embodiments, the XR device 302 detects the input using one or more other devices (e.g., second device 112 of FIG. 1).

In some embodiments, the XR device 302 identifies one or more devices associated with the first input. For example, if the first input is the user gazing at the first device 304, then the first device 304 may be associated with the first input. In another example, if the first input is a user selection of the application 306 on the first device 304, then the first device 304 may be associated with the first input. The XR device 302 may use one or more sensors described herein to identify one or more devices associated with the first input.

The XR device 302 may also identify a first set of attributes associated with the first device 304. For example, the first set of attributes may comprise brightness, health, notification, media sharing, and/or similar such attributes. In some embodiments, the XR device 302 identifies the first set of attributes using one or more databases. For example, a first database may store attributes associated with devices in one or more profiles. In some embodiments, a control hub (e.g., control hub 614) stores device information and/or attributes associated with the devices. In some embodiments, one or more devices communicate with each other and/or with a control hub using one or more wired and/or wireless communication protocols.

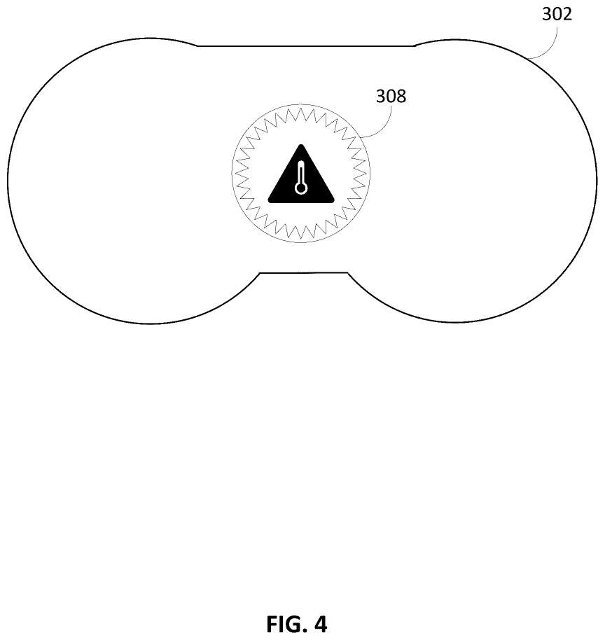

In some embodiments, the XR device 302 detects a second input. For example, the XR device 302 may detect a second input when the user gazes at a second device 308 as shown in FIG. 4. The XR device 302 may identify one or more devices associated with the second input. For example, if the second input is the user gazing at the second device 308, then the second device 308 may be associated with the second input. In some embodiments, the XR device 302 uses one or more sensors described herein to identify one or more devices associated with the second input. The XR device 302 may also identify a second set of attributes associated with the second device 308. For example, the second set of attributes may comprise comfort, health, energy, and/or similar such attributes. In some embodiments, the XR device 302 identifies the second set of attributes using one or more databases.

In some embodiments, the XR device 302 identifies one or more actions based on the first input, the second input, the first set of attributes, and/or the second set of attributes. For example, the XR device 302 may determine that the first set of attributes and the second set of attributes both comprise “health.” Since the first set of attributes and the second set of attributes both comprise “health,” the XR device 302 may determine one or more actions (e.g., turning on the air conditioning) related to the second device 308.

In some embodiments, the XR device 302 identifies one or more actions associated with one or more devices using one or more databases. For example, a database may comprise a plurality of entries linking devices to one or more actions. A first entry may link a first plurality of actions (e.g., turning on the air conditioning, turning off the air conditioning, turning on a heater, turning of the heater, etc.) with the second device 308. A second entry may link a second plurality of actions (e.g., turning up the brightness, turning down the brightness, activating silent mode, transmitting a message, playing a piece of content, launching an application, setting an alarm, turning off the device, turning on the device, etc.) with the first device 304. The entries may also associate the plurality of actions with one or more attributes. For example, the first entry may link a first action (e.g., turning on the air conditioning) with a first attribute (e.g., health, temperature, etc.). In another example, the second entry may link a second action (e.g., launching an application 306 related to fitness) with a first attribute (e.g., health).

In some embodiments, the XR device 302 also displays one or more display elements related to one or more of the identified actions. For example, the XR device 302 may display a first display element 310 in response to identifying a first action (e.g., turning on the air conditioning). In some embodiments, the first display element 310 is selectable. In some embodiments, one or more display elements comprise one or more selectable options. A user may interact with one or more display elements using a voice query, gesture, gaze, and/or similar such input. For example, a user selection may be a voice query associated with the first display element 310. In another example, a user selection may be a tap of a touch display of the XR device 302. In another example, the user selection may be the user gazing at the first display element 310. In another example, the user selection may be the user making a gesture with their hand. In another example, the user selection may be the user blinking and/or moving their eyes. The XR device 302 may use any of the sensors described herein to detect the selection. The XR device 302 may cause the second device 308 to perform the one or more actions in response to the user interacting with the one or more display elements.

In some embodiments, the XR device 302 displays the first display element 310 based on one or more attributes (e.g., health) of the second device 308 matching one or more attributes (e.g., health) of the first device 304. In some embodiments, different display elements are associated with different attributes. For example, the first display element 310 may be associated with a first attribute (e.g., health) and a second display element (not shown) may be associated with a second attribute (e.g., energy).

In some embodiments, the XR device 302 causes the second device 308 to perform the one or more actions without displaying the first display element 310. For example, the XR device 302 may automatically cause the second device 308 to turn on the air conditioning after detecting the second input. In some embodiments, the XR device 302 automatically causes the second device 308 to perform the one or more actions based, at least in part, on the second input and past user interactions. For example, the XR device 302 may have access to one or more databases that store user interactions. The XR device 302 may use the one or more databases and one or more artificial intelligence (AI) models to identify user patterns. For example, the XR device 302 may use an AI model and the database to determine that the user consistently uses the second device 308 to turn on the air conditioning while the user is using the application 306 (e.g., fitness application) on the first device 304. Accordingly, when a user launches the application 306 on the first device 304 and then gazes at the second device 308, the XR device 302 may automatically cause the second device 308 to turn on the air conditioning based on the past user interactions.

In some embodiments, the XR device 302 detects a first input when the user gazes at a television (e.g., second device 112 shown in FIG. 1). The XR device 302 may use one or more sensors to detect the first input. The XR device 302 may then identify one or more devices associated with the first input. For example, if the first input is the user gazing at the television, then the television may be associated with the first input. The XR device 302 may use one or more sensors to identify the television. The XR device 302 may also identify a first set of attributes associated with the television. For example, the first set of attributes may comprise brightness, audio, media sharing, and/or similar such attributes. In some embodiments, the XR device 302 identifies the first set of attributes using one or more databases.

The XR device 302 may then detect a second input. For example, the XR device 302 may detect the second input when the user gazes at a smart light (e.g., third device 114 shown in FIG. 1). The XR device 302 may use one or more sensors to detect the second input. The XR device 302 may then identify one or more devices associated with the second input. For example, if the second input is the user gazing at the light, then the light may be associated with the second input. The XR device 302 may use one or more sensors to identify the light. The XR device 302 may also identify a second set of attributes associated with the light. For example, the second set of attributes may comprise brightness, energy, and/or similar such attributes. In some embodiments, the XR device 302 identifies the second set of attributes using one or more databases.

The XR device 302 may also identify one or more actions based on the first input, the second input, the first set of attributes, and/or the second set of attributes. For example, the XR device 302 may determine that the first set of attributes and the second set of attributes both comprise “brightness.” Since the first set of attributes and the second set of attributes both comprise “brightness,” the XR device 302 may determine one or more actions (e.g., brightness control related to the light). In some embodiments, the XR device 302 displays one or more display elements related to one or more of the identified actions. For example, the XR device 302 may display a display element in response to identifying a first action (e.g., brightness control). In another example, the XR device 302 may cause another device (e.g., the television) to display the display element in response to identifying a first action (e.g., brightness control). In some embodiments, the XR device 302 causes the light to perform one or more actions (e.g., turn down the brightness, turn up the brightness, etc.) in response to the user interacting with the one or more display elements. In some embodiments, the XR device 302 causes the light to perform one or more actions (e.g., turn down the brightness, turn up the brightness, etc.) without displaying a display element. For example, the XR device 302 may automatically cause the light to turn down the brightness after detecting the second input (e.g., the user gazing at the light).

In some embodiments, the XR device 302 detects a first input when the user issues a voice query (e.g., “transfer”). The XR device 302 may use one or more sensors to detect the first input. The XR device 302 may then identify one or more devices associated with the first input. For example, if the user is gazing at a laptop while issuing the voice query, then the laptop may be associated with the first input. The XR device 302 may use one or more sensors to identify the laptop. The XR device 302 may also identify a first set of attributes associated with the laptop. For example, the first set of attributes may comprise brightness, audio, notification, media sharing, and/or similar such attributes. In some embodiments, the XR device 302 identifies the first set of attributes using one or more databases.

The XR device 302 may then detect a second input. For example, the XR device 302 may detect the second input when the user gazes at a smartphone (e.g., fourth device 116 shown in FIG. 1). The XR device 302 may use one or more sensors to detect the second input. The XR device 302 may then identify one or more devices associated with the second input. For example, if the second input is the user gazing at the smartphone, then the smartphone may be associated with the second input. The XR device 302 may use one or more sensors to identify the smartphone. The XR device 302 may also identify a second set of attributes associated with the smartphone. For example, the second set of attributes may brightness, audio, notification, media sharing, and/or similar such attributes. In some embodiments, the XR device 302 identifies the second set of attributes using one or more databases.

The XR device 302 may also identify one or more actions based on the first input, the second input, the first set of attributes, and/or the second set of attributes. For example, the XR device 302 may determine that the first input (e.g., voice query of “transfer”) corresponds to a plurality of actions related to a media transfer between the identified devices. The first action of the plurality of actions may relate to identifying the piece of content to be transferred. The XR device 302 may identify the piece of content based on the first input. For example, the XR device 302 may identify a piece of content that is displayed by the laptop within a threshold time of when the first input is received. In another example, the XR device 302 may identify a piece of content that is selected by the user within a threshold time of when the first input is received. The second action of the plurality of actions may be to format the identified piece of content. For example, the XR device 302 may cause the laptop to resize the identified piece of content according to one or more specifications of the receiving device (e.g., the smartphone). In another example, the XR device 302 may cause the laptop to convert the identified piece of content from a first format to a second format to facilitate transferring the piece of content to the receiving device (e.g., smartphone). The third action of the plurality of actions may be to transfer the formatted piece of content to the receiving device. For example, the XR device 302 may cause the laptop to transmit the formatted piece of content to the smartphone. In another example, the XR device 302 may cause the laptop to transmit a link to the formatted piece of content and/or to the identified piece of content so the smartphone can download the identified piece of content.

In some embodiments, the XR device 302 displays one or more display elements related to one or more of the identified actions. For example, the XR device 302 may display a display element requesting an authorization to cause the laptop to transfer a piece of media to smartphone. In another example, the XR device 302 may cause another device (e.g., the laptop, smartphone, etc.) to display the display element in response to identifying the one or more actions.

In some embodiments, the XR device 302 causes the laptop and/or the smartphone to perform one or more actions in response to the user interacting with the one or more display elements. In some embodiments, the XR device 302 causes the laptop and/or the smartphone to perform one or more actions without displaying a display element. For example, the XR device 302 may automatically cause the plurality of actions related to a media transfer between the identified devices after detecting the second input (e.g., the user gazing at the smartphone).

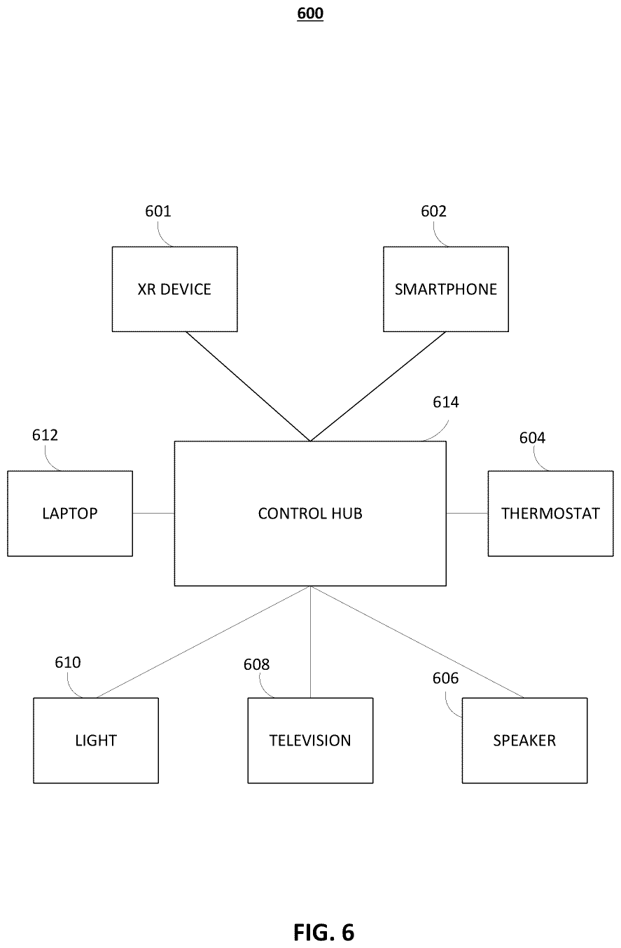

FIGS. 6-8 describe exemplary devices, systems, servers, and related hardware for displaying control elements for devices based on one or more inputs, in accordance with some embodiments.

FIG. 6 shows a system 600 comprising an XR device 601, a smartphone 602, a thermostat 604, a speaker 606, a television 608, a light 610, and a laptop 612 coupled to a control hub 614. In some embodiments, one or more devices communicate with the control hub 614 using wired and/or wireless communications paths. Although seven devices are shown, any number of devices may be used. For example, there may be more or less devices than shown. In some embodiments, one or more devices are the same or similar to other devices described herein.

The system 600 may identify one or more the devices using one or more registration processes. During a registration process, the system 600 may receive device information. The system 600 may use the device information to determine attributes about each device. For example, the smartphone 602 may be associated with a first set of attributes (e.g., brightness, volume, media sharing, and/or similar such attributes) and the light 610 may be associated with a second attribute (e.g., brightness). The system 600 may store the attributes associated with each device in one or more databases. In some embodiments, the control hub 614 stores the device information and/or attributes associated with the plurality of devices. In some embodiments, the devices communicate with each other and/or with the control hub 614 using one or more wired and/or wireless communication protocols. For example, the plurality of devices may communicate via a Wi-Fi network.

In some embodiments, the device information and/or attributes associated with the plurality of devices are received from the plurality of devices. For example, the thermostat 604 may store a first Extensible Markup Language (XML) file in the memory of the thermostat 604 and the television 608 may store a second XML file in the memory of the television 608. The thermostat 604 may broadcast first XML data contained in the first XML file over a network (e.g., Wi-Fi network). The television 608 may broadcast second XML data contained in the second XML file over the network. In some embodiments, the thermostat 604 and/or the television 608 broadcast the XML data using one or more discovery protocols (e.g., Universal Plug and Play (UPnP), Simple Service Discovery Protocol (SSDP), etc.). One or more devices (e.g., the control hub 614) may receive the first XML data and/or the second XML data. The one or more devices may then store the first XML data and/or the second XML data in one or more databases. The stored XML data may be used to generate one or more entries described herein.

In some embodiments, the device information comprises one or more actions associated with one or more devices. The system 600 may store the one or more actions associated with the one or more devices in one or more databases. The one or more databases may comprise a plurality of entries linking devices to one or more actions. For example, an entry may link a first plurality of actions (e.g., turning on the air conditioning, turning off the air conditioning, turning on a heater, turning of the heater, etc.) with the thermostat 604. In another example, an entry may link a second plurality of actions (e.g., turning up the brightness, turning down the brightness, activating silent mode, transmitting a message, playing a piece of content, launching an application, setting an alarm, turning off a device, turning on a device, etc.) with the smartphone 602. The entries may also associate the one or more actions with one or more attributes. For example, an entry may link a first action (e.g., turning on the air conditioning) with a first attribute (e.g., health). In another example, an entry may link a second action (e.g., launching an application related to fitness) with a first attribute (e.g., health).

In some embodiments, the one or more databases described herein are data structures. In some embodiments, the data structures comprise device information and/or similar such information. A data structure may store one or more device identifiers. The device identifiers may be unique identifiers for each device. For example, a device identifier associated with the XR device 601 may be XR_01 and a device identifier associated with the television may be TV_01. The data structure may also store a plurality of attributes for the one or more devices. For example, the data structure may store a first set of attributes (e.g., brightness, volume, media sharing, and/or similar such attributes) associated with the smartphone 602 and may store a second set of attributes (e.g., brightness, energy, and/or similar such attributes) associated with the light 610. The data structure may also store user interactions associated with the one or more devices. For example, the data structure may store one or more inputs related to the one or more devices (e.g., the frequency that the user turns off the light 610 when turning on the television 608). The data structure may also store user preferences associated with the one or more devices. For example, the data structure may store a first preference corresponding to a temperature setting for the thermostat 604 and may store a second preference corresponding to a brightness setting for the light 610. The data structure may also store one or more actions associated with one or more devices. For example, the data structure may store one or more actions (e.g., turning on the air conditioning, turning off the air conditioning, turning on a heater, turning of the heater, etc.) associated with the thermostat 604. In some embodiments, the data structure is lightweight and optimized for efficient storage on one or more devices and/or cloud services. In some embodiments, the data structure is distributed across one or more memories, control hubs, and/or cloud servers.

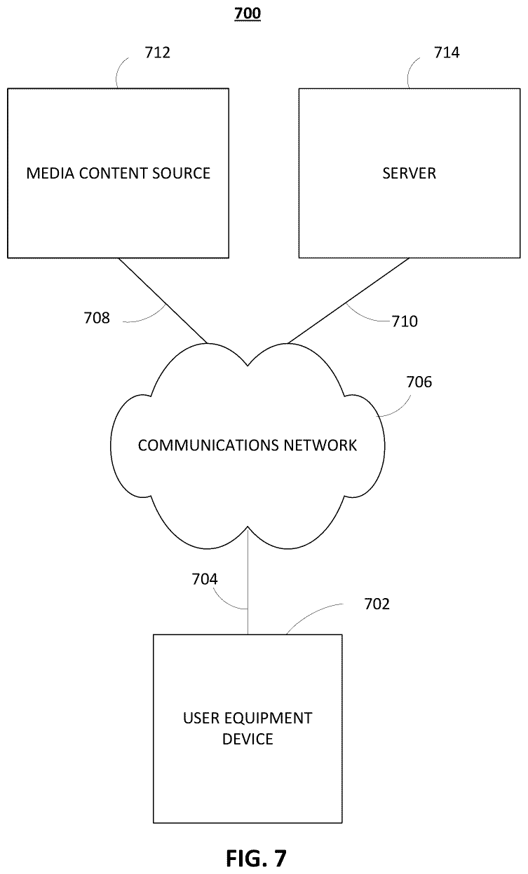

In the system 700, there can be more than one user equipment device 702 but only one is shown in FIG. 7 to avoid overcomplicating the drawing. In addition, a user may utilize more than one type of user equipment device 702 and more than one of each type of user equipment device. As described above, the user equipment device 702 may be an XR device, smartphone, laptop computer, desktop computer, television, speaker, and/or any similar such device. In an embodiment there may be paths between user equipment devices, so that the devices may communicate directly with each other via communications paths, as well as other short-range point-to-point communications paths, such as USB cables, IEEE 1394 cables, wireless paths (e.g., Bluetooth, infrared, IEEE 802-11x, etc.), or other short-range communication via wired or wireless paths. In an embodiment, the user equipment devices may also communicate with each other directly through an indirect path via the communications network 706.

The user equipment device 702, a media content source 712, and a server 714 may be coupled to communications network 706. Namely, the user equipment device 702 is coupled to the communications network 706 via a first communications path 704, the media content source 712 is coupled to the communications network 706 via a second communications path 708, and the server 714 is coupled to the communications network 706 via a third communications path 710. The communications network 706 may be one or more networks including the Internet, a mobile phone network, mobile voice or data network (e.g., a 4G, 5G, or LTE network), cable network, public switched telephone network, or other types of communications network or combinations of communications networks. One or more communications paths may separately or in together with other paths include one or more communications paths, such as, a satellite path, a fiber-optic path, a cable path, a path that supports Internet communications (e.g., IPTV), free-space connections (e.g., for broadcast or other wireless signals), or any other suitable wired or wireless communications path or combination of such paths. In some embodiments, one or more communications paths can be wireless. Communication between devices may be provided by one or more communications paths but is shown as a single path in FIG. 7 to avoid overcomplicating the drawing.

The media content source 712 and the server 714 can be coupled to any number of databases providing information to the user equipment devices. For example, the media content source 712 and/or the server 714 may have access to device attributes, display elements, and/or similar such information. The media content source 712 represents any computer-accessible source of content, such as a storage for media content, audio content, metadata, and/or, similar such information. The media content source 712 and/or the server 714 may store and/or execute various software modules for enabling the displaying of control elements for devices based on one or more inputs functionality. In the system 700, there can be more than one media content source 712 and/or the server 714 but only one of each are shown in FIG. 7 to avoid overcomplicating the drawing. In addition, the system 700 may utilize more than one type of the media content source 712 and/or the server 714 and more than one of each type of the media content source 712 and/or the server 714.

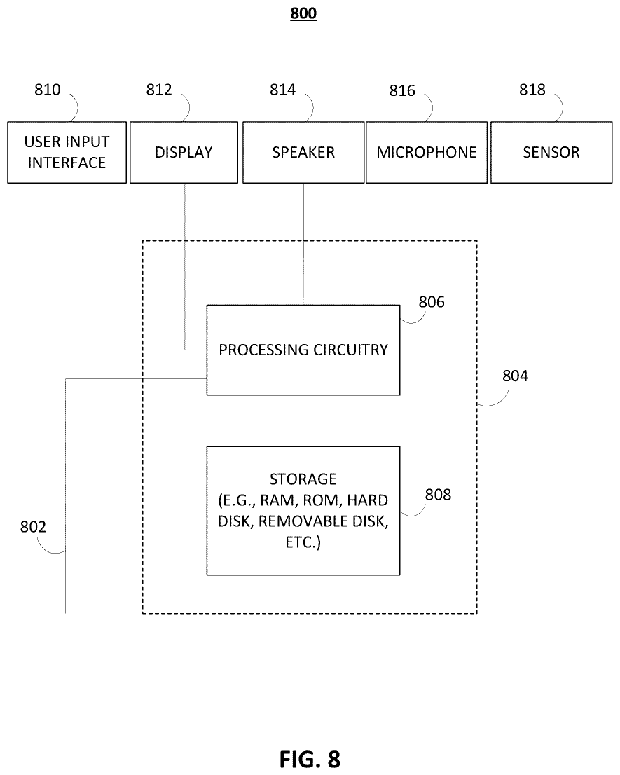

FIG. 8 shows a generalized embodiment of a user equipment device 800, in accordance with some embodiments. In some embodiments, the user equipment device 800, is an example of the user equipment devices described in FIGS. 1-7 (e.g., first device 102). The user equipment device 800 may receive content and data via input/output (I/O) path 802. The I/O path 802 may provide audio content (e.g., broadcast programming, on-demand programming, Internet content, content available over a local area network (LAN) or wide area network (WAN), and/or other content) and data to control circuitry 804, which includes processing circuitry 806 and a storage 808. The control circuitry 804 may be used to send and receive commands, requests, and other suitable data using the I/O path 802. The I/O path 802 may connect the control circuitry 804 (and specifically the processing circuitry 806) to one or more communications paths. I/O functions may be provided by one or more of these communications paths but are shown as a single path in FIG. 8 to avoid overcomplicating the drawing.

The control circuitry 804 may be based on any suitable processing circuitry such as the processing circuitry 806. As referred to herein, processing circuitry should be understood to mean circuitry based on one or more microprocessors, microcontrollers, digital signal processors, programmable logic devices, field-programmable gate arrays (“FPGAs”), application-specific integrated circuits (“ASICs”), etc., and may include a multi-core processor (e.g., dual-core, quad-core, hexa-core, or any suitable number of cores) or supercomputer. In some embodiments, processing circuitry may be distributed across multiple separate processors or processing units, for example, multiple of the same type of processing units (e.g., two Intel Core i7 processors) or multiple different processors (e.g., an Intel Core i5 processor and an Intel Core i7 processor). The displaying of control elements for devices based on one or more inputs functionality can be at least partially implemented using the control circuitry 804. The displaying of control elements for devices based on one or more inputs functionality described herein may be implemented in or supported by any suitable software, hardware, or combination thereof.

In client-server-based embodiments, the control circuitry 804 may include communications circuitry suitable for communicating with one or more servers that may at least implement the described displaying of control elements for devices based on one or more inputs functionality. The instructions for carrying out the above-mentioned functionality may be stored on the one or more servers. Communications circuitry may include a cable modem, an integrated service digital network (“ISDN”) modem, a digital subscriber line (“DSL”) modem, a telephone modem, Ethernet card, or a wireless modem for communications with other equipment, or any other suitable communications circuitry. Such communications may involve the Internet or any other suitable communications networks or paths. In addition, communications circuitry may include circuitry that enables peer-to-peer communication of user equipment devices, or communication of user equipment devices in locations remote from each other (described in more detail below).

Memory may be an electronic storage device provided as the storage 808 that is part of the control circuitry 804. As referred to herein, the phrase “electronic storage device” or “storage device” should be understood to mean any device for storing electronic data, computer software, or firmware, such as random-access memory, read-only memory, hard drives, optical drives, digital video disc (“DVD”) recorders, compact disc (“CD”) recorders, BLU-RAY disc (“BD”) recorders, BLU-RAY 3D disc recorders, digital video recorders (“DVR”, sometimes called a personal video recorder, or “PVR”), solid-state devices, quantum storage devices, gaming consoles, gaming media, or any other suitable fixed or removable storage devices, and/or any combination of the same. The storage 808 may be used to store various types of content described herein. Nonvolatile memory may also be used (e.g., to launch a boot-up routine and other instructions). In some embodiments, cloud-based storage may be used to supplement the storage 808 or instead of the storage 808.

Control circuitry 804 may include video generating circuitry and tuning circuitry, such as one or more analog tuners, one or more MPEG-2 decoders or MPEG-2 decoders or decoders or HEVC decoders or any other suitable digital decoding circuitry, high-definition tuners, or any other suitable tuning or video circuits or combinations of such circuits. Encoding circuitry (e.g., for converting over-the-air, analog, or digital signals to MPEG or HEVC or any other suitable signals for storage) may also be provided. Control circuitry 804 may also include scaler circuitry for upconverting and downconverting content into the preferred output format. Control circuitry 804 may also include digital-to-analog converter circuitry and analog-to-digital converter circuitry for converting between digital and analog signals. The tuning and encoding circuitry may be used by the user equipment device 800 to receive and to display, to play, or to record content. The tuning and encoding circuitry may also be used to receive video communication session data. The circuitry described herein, including for example, the tuning, video generating, encoding, decoding, encrypting, decrypting, scaler, and analog/digital circuitry, may be implemented using software running on one or more general purpose or specialized processors. Multiple tuners may be provided to handle simultaneous tuning functions (e.g., watch and record functions, picture-in-picture (PIP) functions, multiple-tuner recording, etc.). If storage 808 is provided as a separate device from the user equipment device 800, the tuning and encoding circuitry (including multiple tuners) may be associated with storage 808.

The user may utter instructions to the control circuitry 804, which are received by the microphone 816. The microphone 816 may be any microphone (or microphones) capable of detecting human speech. The microphone 816 is connected to the processing circuitry 806 to transmit detected voice commands and other speech thereto for processing. In some embodiments, voice assistants (e.g., Siri, Alexa, Google Home and similar such voice assistants) receive and process the voice commands and other speech.

The user equipment device 800 may optionally include an interface 810. The interface 810 may be any suitable user interface, such as a remote control, mouse, trackball, keypad, keyboard, touch screen, touchpad, stylus input, joystick, or other user input interfaces. A display 812 may be provided as a stand-alone device or integrated with other elements of the user equipment device 800. For example, the display 812 may be a touchscreen or touch-sensitive display. In such circumstances, the interface 810 may be integrated with or combined with the microphone 816. When the interface 810 is configured with a screen, such a screen may be one or more of a monitor, a television, a liquid crystal display (“LCD”) for a mobile device, active matrix display, cathode ray tube display, light-emitting diode display, organic light-emitting diode display, quantum dot display, or any other suitable equipment for displaying visual images. In some embodiments, the interface 810 may be HDTV-capable. In some embodiments, the display 812 may be a 3D display. A speaker 814 may be controlled by the control circuitry 804. The speaker (or speakers) 814 may be provided as integrated with other elements of user equipment device 800 or may be a stand-alone unit. In some embodiments, the display 812 may be outputted through speaker 814.

In some embodiments, the user equipment device 800 may optionally include a sensor 818. Although only one sensor 818 is shown, any number of sensors may be used. In some embodiments, the sensor 818 is a camera, depth sensor, Lidar sensor, location sensor, pressure sensor, accelerometer, audio sensor, and/or any similar such sensor. In some embodiments, the sensor 818 (e.g., image sensor(s) or camera(s)) of the user equipment device 800 may capture the real-world environment around the user equipment device 800. The user equipment device 800 may then render the captured real-world scene on the display 812. The user equipment device 800 may generate for display virtual or augmented objects to be displayed on the display 812, thereby augmenting the real-world scene visible on the display 812.

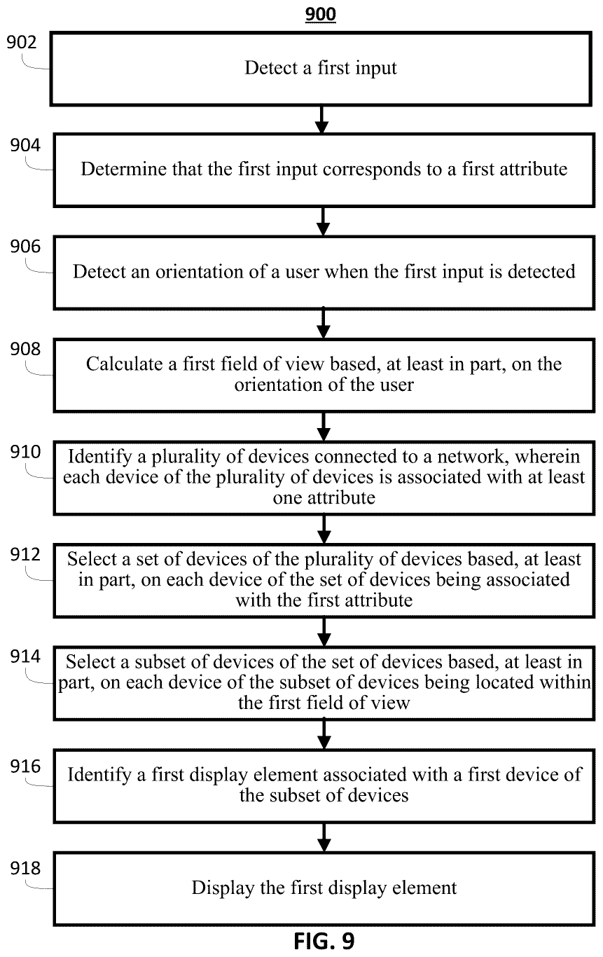

FIG. 9 is an illustrative flowchart of a process 900 for displaying control elements for devices based on one or more inputs, in accordance with some embodiments of this disclosure. Process 900, and any of the following processes, may be executed by control circuitry 804 on a user equipment device 800 and/or by control circuitry on one or more servers. In some embodiments, control circuitry may be part of a remote server separated from the user equipment device 800 by way of a communications network or distributed over a combination of both. In some embodiments, instructions for executing process 900, and any of the following processes, may be encoded onto a non-transitory storage medium (e.g., the storage 808) as a set of instructions to be decoded and executed by processing circuitry (e.g., the processing circuitry 806). Processing circuitry may, in turn, provide instructions to other sub-circuits contained within control circuitry, such as the encoding, decoding, encrypting, decrypting, scaling, analog/digital conversion circuitry, and the like. It should be noted that any of the processes, or any step thereof, could be performed on, or provided by, any of the devices described in FIGS. 1-8. Although the processes are illustrated and described as a sequence of steps, it is contemplated that various embodiments of the processes may be performed in any order or combination and need not include all the illustrated steps. In addition, some suitable steps may be implemented in parallel to further the purposes of this disclosure. For example, some suitable steps may be performed in any order or in parallel or substantially simultaneously to reduce lag or increase the speed of the system or method.

At 902, control circuitry detects a first input. In some embodiments, the first input may be a voice query, gesture, gaze, and/or similar such input. For example, a first input may be a voice query (e.g., “increase brightness”). In another example, the first input may a tap of a touch display. In another example, the first input may be the user gazing at one or more devices. In another example, the first input may be the user pointing at one or more devices. In another example, the first input may be the user blinking and/or moving their eyes. The control circuitry may use one or more sensors to detect the first input. The one or more sensors may include a camera, depth sensor, Lidar sensor, location sensor, pressure sensor, accelerometer, audio sensor, and/or similar such sensors.

At 904, control circuitry determines that the first input corresponds to a first attribute. In some embodiments, the control circuitry uses one or more machine learning models to determine an attribute associated with the first input. In some embodiments, the control circuitry uses one or more natural language processing (NLP) models to determine an attribute associated with the first input. For example, the control circuitry may use an NLP to determine that a voice query (e.g., “increase brightness”) corresponds to a first attribute (e.g., brightness). In some embodiments, the control circuitry has access to a database linking inputs to attributes. For example, a first input (e.g., user gazing at a lamp) may correspond to a first attribute (e.g., brightness). In another example, a second input (e.g., user gesturing at a laptop) may correspond to a second attribute (e.g., media sharing).

At 906, control circuitry detects an orientation of a user when the first input is detected. For example, the control circuitry may determine that the user is wearing an XR device and the XR devices detects an orientation of the user's head when the first input is detected. In another example, one or more cameras may capture one or more images of a user when the first input is detected. The control circuitry may use one or more image detection models to process the one or more images of the user to determine the orientation of the head of the user when the first input is detected. In another example, one or more cameras may capture one or more images of a user when the first input is detected. The control circuitry may use one or more image detection models to process the one or more images of the of the user to determine the location of one or more eyes and/or pupils of the user. In some embodiments, the orientation of the user is detected within a threshold (e.g., one second, five seconds, thirty seconds, etc.) of when the first input is detected.

At 908, control circuitry calculates a first field of view based, at least in part, on the orientation of the user. In some embodiments, the control circuitry uses any of the sensors and/or models described herein to detect and/or determine the first field of view of the user.

At 910, control circuitry identifies a plurality of devices connected to a network, wherein each device of the plurality of devices is associated with at least one attribute. In some embodiments, the network is a home network, and the plurality of devices are smart devices connected to the home network. In some embodiments, the control circuitry identifies each device of the plurality of devices using one or more registration processes. During the registration process the control circuitry may receive device information. The control circuitry may use the device information to determine attributes and/or action relating to each device. For example, the first device may be associated with a first set of attributes (e.g., brightness, volume, media sharing, and/or similar such attributes) and second device may be associated with a second attribute (e.g., brightness). The control circuitry may store the attributes and/or actions associated with each device in one or more databases. In some embodiments, the control circuitry communicate with one or more devices of the plurality of devices using one or more wired and/or wireless communication protocols.

At 912, control circuitry selects a set of devices of the plurality of devices based, at least in part, on each device of the set of devices being associated with the first attribute. In some embodiments, the control circuitry uses one or more attributes of the devices to determine one or more devices associated with the first input. For example, the first input may be a voice query of “increase brightness” and the first attribute may be “brightness.” The control circuitry may identify a first device (e.g., a television), a second device (e.g., a light), and a third device (e.g., a smartphone) as the set of devices because each device of the set of devices are associated with an attribute that is the same or similar to the first attribute (e.g., brightness). In another example, the first input may be a voice query of “decrease volume” and the first attribute may be “volume.” The control circuitry may identify the first device (e.g., a television) and the third device (e.g., a smartphone) as the set of devices because each device of the set of devices are associated with an attribute that is the same or similar to the first attribute (e.g., volume).

At 914, control circuitry selects a subset of devices of the set of devices based, at least in part, on each device of the subset of devices being located within the first field of view. For example, the first input may be a voice query of “increase brightness” and the first attribute may be “brightness.” The control circuitry may identify a first device (e.g., a television), a second device (e.g., a light), and a third device (e.g., a smartphone) as the set of devices because each device of the set of devices are associated with an attribute that is the same or similar to the first attribute (e.g., brightness). The control circuitry may then select the first device and the second device as the subset of devices because they are both within the field of view calculated at step 908. In some embodiments, the control circuitry selects a single device. For example, the first input may be a voice query of “decrease volume” and the first attribute may be “volume.” The control circuitry may identify the first device (e.g., a television) and the third device (e.g., a smartphone) as the set of devices because each device of the set of devices are associated with an attribute that is the same or similar to the first attribute (e.g., volume). The control circuitry may then select only the first device because the first device is within the field of view calculated at step 908 and the third device is not located within the field of view.

At 916, control circuitry identifies a first display element associated with a first device of the subset of devices. The first display element may relate to one or more actions of the first devices. For example, the display elements may relate to brightness setting controls, temperature setting controls, volume setting controls, media output controls, media transfer controls, activation controls, and/or similar such controls. In some embodiments, the one or more display elements relate to the first attribute of step 904. For example, the first input may be a voice query of “increase brightness” and the first attribute may be “brightness.” The display element may be a brightness setting control for the first device because the brightness setting control corresponds to the first attribute.

At 918, control circuitry displays the first display element. In some embodiments, the control circuitry accesses the first display element from one or more databases. For example, the device information received and stored in a database during one or more device registration processes may comprise the first display element. In some embodiments, the control circuitry receives the first display element from one or more devices. For example, the control circuitry may request the first display element from the first device and the first device transmits the first display element to the control circuitry for display. In another example, the control circuitry may request the first display element from the first device and the first device transmits the first display element to an additional device for display.

In some embodiments, the first display element and/or portions of the display element are selectable. For example, the control circuitry may display the first display element (e.g., brightness setting controls for the first device). The user may select the first display element to adjust the brightness settings of the first device.

The control circuitry may cause one or more devices to perform an action in response to the selection of the first display element. For example, if the selection of the first display element corresponds to decreasing the brightness of the first device, then the control circuitry may send a request to the first device to decrease the brightness settings according to the selection of the first display element. In another example, if the selection of the first display element corresponds to decreasing the brightness of the first device, then the control circuitry may send a first request to an additional device (e.g., control hub). The additional device may then send a second request to the first device to decrease the brightness settings according to the selection of the first display element.

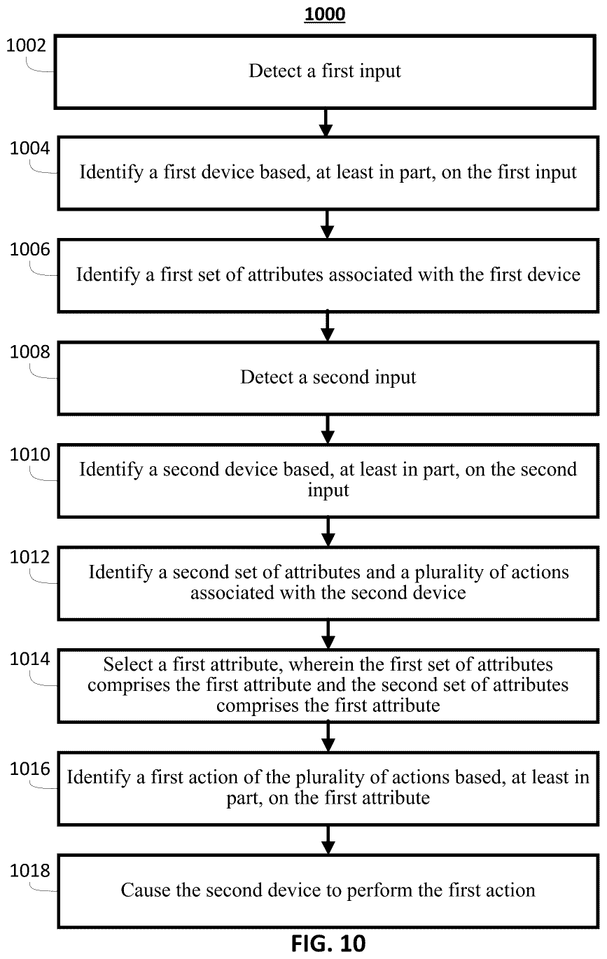

FIG. 10 is an illustrative flowchart of a process 1000 for displaying control elements for devices based on one or more inputs, in accordance with some embodiments of this disclosure.

At 1002, control circuitry detects a first input. In some embodiments, the control circuitry uses the same or similar methodologies described at step 902 to detect the first input.

At 1004, control circuitry identifies a first device based, at least in part, on the first input. For example, if the first input is the user gazing at the first device, then the first device may be associated with the first input. In another example, if the first input is a user selection of the application on the first device, then the first device may be associated with the first input. The control circuitry may use one or more sensors described herein to identify one or more devices associated with the first input.

At 1006, control circuitry identifies a first set of attributes associated with the first device. For example, the first device may be a smartphone and the first set of attributes may comprise brightness, health, notification, media sharing, and/or similar such attributes. In some embodiments, the control circuitry identifies the first set of attributes using one or more databases. For example, a database may store attributes associated with devices in one or more profiles. In some embodiments, an additional device (e.g., control hub) stores device information and/or attributes associated with the devices and the control circuitry requests the first set of attributes from the additional device.

At 1008, control circuitry detects a second input. In some embodiments, the control circuitry uses the same or similar methodologies described at step 902 to detect the second input.

At 1010, control circuitry identifies a second device based, at least in part, on the second input. In some embodiments, the control circuitry uses the same or similar methodologies described at step 1004 to identify the second device based, at least in part, on the second input.

At 1012, control circuitry identifies a second set of attributes and a plurality of actions associated with the second device. For example, the second device may be a thermostat and the second set of attributes may comprise comfort, health, energy, and/or similar such attributes. In some embodiments, the control circuitry identifies the second set of attributes using one or more databases. For example, a database may store attributes associated with devices in one or more profiles. In some embodiments, an additional device (e.g., control hub) stores device information and/or attributes associated with the devices and the control circuitry requests the second set of attributes from the additional device.

At 1014, control circuitry selects a first attribute, wherein the first set of attributes comprises the first attribute and the second set of attributes comprises the first attribute. For example, the control circuitry may determine that the first set of attributes and the second set of attributes both comprise “health.” In some embodiments, the control circuitry also uses the first input and/or the second input to select the first input. For example, if the first set of attributes and the second set of attributes have more than one attribute in common, the control circuitry may use the first input and/or the second input to select the first attribute of the plurality of common attributes.

At 1016, control circuitry identifies a first action of the plurality of actions based, at least in part, on the first attribute. For example, if the first set of attributes and the second set of attributes both comprise “health,” then the control circuitry may determine one or more actions (e.g., turning on the air conditioning) related to the first device. In some embodiments, the control circuitry identifies one or more actions associated with one or more devices using one or more databases. For example, a database may comprise a plurality of entries linking devices to one or more actions. A first entry may link a first plurality of actions (e.g., turning up the brightness, turning down the brightness, activating silent mode, transmitting a message, playing a piece of content, launching an application, setting an alarm, turning off the device, turning on the device, etc.) with the first device. A second entry may link a second plurality of actions (e.g., turning on the air conditioning, turning off the air conditioning, turning on a heater, turning of the heater, etc.) with the second device. The entries may also associate the plurality of actions with one or more attributes. For example, the first entry may link a first action (e.g., launching an application related to fitness) with the first attribute (e.g., health). In another example, a second entry may link a second action (e.g., turning on the air conditioning) with the first attribute (e.g., health).

At 1018, control circuitry causes the second device to perform the first action. For example, the control circuitry may automatically cause the second device (e.g., thermostat) to turn on the air conditioning after detecting the second input (e.g., gazing at the thermostat). In some embodiments, the control circuitry automatically causes the second device to perform the one or more actions based, at least in part, on the second input and past user interactions. For example, the control circuitry may have access to one or more databases that store user interactions. Using the database, the control circuitry may determine that the user consistently uses the second device to turn on the air conditioning after the first input (e.g., launching a fitness application on the first device). Accordingly, when the control circuitry detects a first input (e.g., first device launching a fitness application) and a second input (e.g., user gazing at the second device), then the control circuitry may automatically cause the second device to perform the first action (e.g., turn on the air conditioning) based on the past user interactions.

In some embodiments, the control circuitry causes the second device to perform the first action in response to an interaction with one or more display elements. For example, the control circuitry may display a display element corresponding to the first action (e.g., turn on the air conditioning). If the control circuitry receives a selection of the display element, then the control circuitry may cause the second device to turn on the air conditioning. In some embodiments, the control circuitry may cause the second device to perform the first action by transmitting a request to the second device. For example, the control circuitry may send a request to the second device to turn on the air conditioning. In some embodiments, the control circuitry may cause the second device to perform the first action by transmitting a request to an additional device. For example, the control circuitry may send a first request to an additional device (e.g., control hub), wherein the first request indicates a request for the second device to turn on the air conditioning. The additional device may then send a second request to the second device to turn on the air conditioning according to the first request.

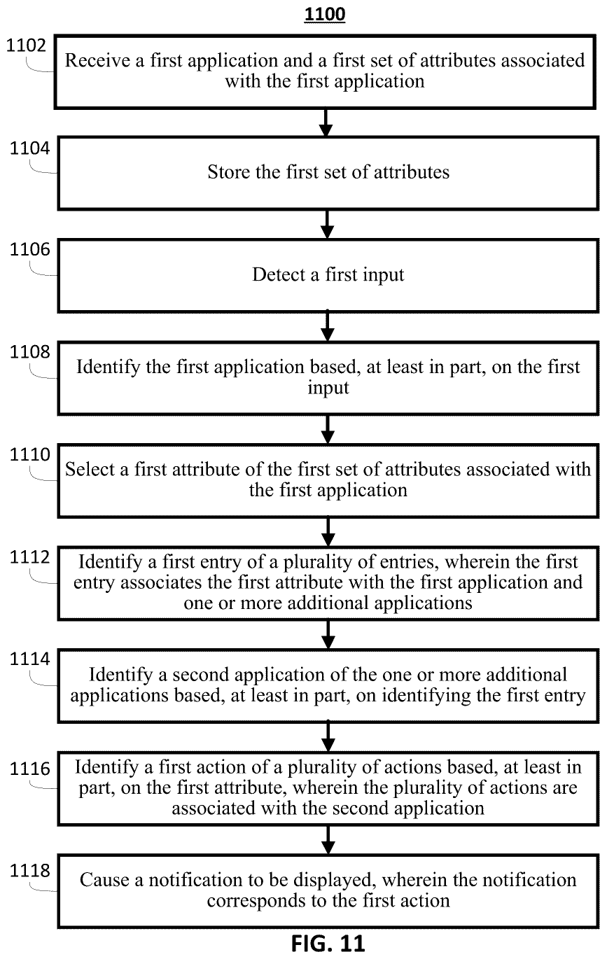

FIG. 11 is an illustrative flowchart of a process 1100 for displaying notifications based on one or more inputs, in accordance with some embodiments of this disclosure.

At 1102, control circuitry receives a first application and a first set of attributes associated with the first application. In some embodiments, the control circuitry receives the first application when the first application is downloaded onto storage (e.g., storage 808) of a device (e.g., XR device, smartphone, laptop, etc.). For example, a smartphone may download a fitness application hosted on an application store (e.g., Apple's App Store). The control circuitry may also receive a first set of attributes associated with the first application. For example, a set of attributes associated with a fitness application may comprise health, entertainment, and/or similar such attributes. In another example, a set of attributes associated with a music playlist application (e.g., Spotify, Apple Music, YouTube Music, Pandora, etc.) may comprise relaxation, health, entertainment, and/or similar such attributes. The first set of attributes may be received along with the first application and/or may be determined by the control circuitry.

In some embodiments, one or more applications are associated with one or more configuration files. For example, the first application may be associated with a first configuration file. The first configuration file may comprise metadata related to the first application. For example, the metadata may indicate a first set of attributes associated with the first application, application compatibility associated with the first application, and/or similar such application information. In some embodiments, the control circuitry uses the application information to determine compatibility between one or more applications. For example, the application information comprises Uniform Resource Locators (URLs) linking compatible applications with the first application. The control circuitry may use the URLs to identify applications that are compatible with the first application. In another example, the application information comprises application extensions linking compatible applications with the first application. The control circuitry may use the application extensions to identify applications that are compatible with the first application. In another example, the application information comprises one or more universal links, linking compatible applications with the first application. The control circuitry may use the one or more universal links to identify applications that are compatible with the first application.

At 1104, control circuitry stores the first set of attributes. In some embodiments, the control circuitry stores the first set of attributes in one or more databases. For example, a database may store attributes associated with one or more applications and/or devices. In some embodiments, the one or more databases comprise a plurality of entries that associate attributes with applications. For example, a first entry may associate a fitness application, a music playlist application, and a thermostat application with the attribute of health. In another example, a first entry may associate a light control application, an email application, a message application, and a thermostat application with the attribute of sleep. The control circuitry may update the one or more databases as the control circuitry receives additional applications and/or attributes.

At 1106, control circuitry detects a first input. In some embodiments, the first input may be a voice query, gesture, gaze, and/or similar such input. For example, a first input may be a user selecting the first application using a touch screen display. In another example, a first input may be a user selecting the first application using a mouse. In another example, a first input may be a voice query (e.g., “open fitness application”). In another example, the first input may a tap of a touch display. In another example, the first input may be the user gazing at one or more devices and/or applications. In another example, the first input may be the user pointing at one or more devices and/or applications. In another example, the first input may be the user blinking and/or moving their eyes. The control circuitry may use one or more sensors to detect the first input. The one or more sensors may include a camera, depth sensor, Lidar sensor, location sensor, pressure sensor, accelerometer, audio sensor, and/or similar such sensors.

At 1108, control circuitry identifies the first application based, at least in part, on the first input. For example, if the first input is a user selecting the first application using a touch screen display, then the first application may be associated with the first input. In another example, if the first input is the user gazing at the first application, then the first application may be associated with the first input. The control circuitry may use one or more sensors described herein to identify one or more applications associated with the first input.

At 1110, control circuitry selects a first attribute of the first set of attributes associated with the first application. At 1112, control circuitry identifies a first entry of a plurality of entries, wherein the first entry associates the first attribute with the first application and one or more additional applications. For example, the first set of attributes associated with a fitness application may comprise health, entertainment, and/or similar such attributes. The control circuitry may select “health” as the first attribute. The control circuitry may then identify that a first entry associates the first attribute (health) with the first application (e.g., fitness application) a second application (e.g., music playlist application), and a third application (e.g., thermostat application).

At 1114, control circuitry identifies a second application of the one or more additional applications based, at least in part, on identifying the first entry. For example, the one or more additional applications associated with the first entry may be the second application (e.g., music playlist application) and/or the third application (e.g., thermostat application). The control circuitry may select the second application (e.g., music playlist application).

At 1116, control circuitry identifies a first action of a plurality of actions based, at least in part, on the first attribute, wherein the plurality of actions are associated with the second application. In some embodiments, the control circuitry identifies the first action when the second application transmits the first action to the control circuitry. For example, the control circuitry may issue a first prompt to one or more applications (including the second application) identified at step 1112. The first prompt may indicate that an input related to the first attribute (e.g., health) is detected. The second application may then issue a second prompt indicating the first action (e.g., play a workout playlist). In some embodiments, the control circuitry receives a plurality of prompts from the applications that receive the first prompt from the control circuitry.

In some embodiments, the control circuitry identifies one or more actions associated with the second application using one or more databases. For example, a database may comprise a plurality of entries linking applications to one or more actions. A first entry may link a first plurality of actions (e.g., playing a playlist, turning up the volume, turning down the volume, skipping a song, and/or similar such actions) with the second application. The entries may also associate the plurality of actions with one or more attributes. For example, the first entry may link a first action (e.g., playing a workout playlist) with the first attribute (e.g., health, temperature, weather, etc.). In another example, a second entry may link a second action (e.g., turning on the air conditioning) with the first attribute (e.g., health). The control circuitry may identify the first action (e.g., playing a workout playlist) using the database and/or the first attribute.

At 1118, control circuitry causes a notification to be displayed, wherein the notification corresponds to the first action. In some embodiments, the notification and/or portions of the notification are selectable. For example, the control circuitry may display a first notification (e.g., “Do you want me to play your workout playlist?”). In response to the user selecting the first notification, the control circuitry may cause the second application (e.g., music playlist application) to perform the first action (e.g., play a workout playlist). In some embodiments, the control circuitry receives the notification from the second application.

In some embodiments, the control circuitry causes more than one notification to be displayed. In some embodiments, the notifications relate to more than one application. For example, the control circuitry may identify a plurality of applications associated with the first attribute at step 1114. The control circuitry may transmit a first prompt to the plurality of applications. The first prompt may indicate that an input related to the first attribute (e.g., health or fitness) is detected. A second application (e.g., music playlist application) may issue a second prompt indicating a first action (e.g., play a workout playlist) and a third application (e.g., thermostat application) may issue a third prompt indicating a second action (e.g., turn on the air conditioning). The control circuitry may then display both a first notification (e.g., “Do you want me to play your workout playlist?”) and a second notification (e.g., “Do you want me to turn on the air conditioner,” “Do you want me to adjust the temperature to 78 degrees,” etc.). The second notification may require an answer from the user, such as, ‘78 degrees.’ In some embodiment, the prompt(s) is/are conditional and associated with a criterion that has to be met before the action associated with the prompt is executed. An example of a conditional prompt may include “should I play your workout playlist when you start working out?” The condition in this scenario is starting a workout session. For example, if the fitness application determines that the user started working out (e.g., based on receiving such signal or information from a smart treadmill), then the control circuitry can inform the related applications of the start of such activity.

In some embodiments, the control circuitry use one or more AI models and/or stored user interactions to present notifications and/or to surface applications. Surfacing application may relate to presenting application information, rearranging displayed applications, prioritizing applications (e.g., during a search), and/or similar such functionalities. The control circuitry may have access to one or more databases that store user interactions. The control circuitry may use the one or more databases and an AI model to identify user patterns. For example, the control circuitry may use an AI model and the database to determine that the user consistently turns on the headlights of a vehicle at night. Accordingly, when a user gazes at a display in the vehicle at night, the control circuitry may automatically cause a first notification (e.g., “Do you want me to turn on the headlights?”) to be displayed by the display. In response to the user selecting the notification, the control circuitry may cause the headlights of the vehicle to be dimmed.

The processes discussed above are intended to be illustrative and not limiting. One skilled in the art would appreciate that the steps of the processes discussed herein may be omitted, modified, combined, and/or rearranged, and any additional steps may be performed without departing from the scope of the invention. More generally, the above disclosure is meant to be exemplary and not limiting. Only the claims that follow are meant to set bounds as to what the present invention includes. Furthermore, it should be noted that the features and limitations described in any one embodiment may be applied to any other embodiment herein, and flowcharts or examples relating to one embodiment may be combined with any other embodiment in a suitable manner, done in different orders, or done in parallel. In addition, the systems and methods described herein may be performed in real time. It should also be noted that the systems and/or methods described above may be applied to, or used in accordance with, other systems and/or methods.

1. A method comprising:
detecting, by a first device, a first input;
determining that the first input corresponds to a first attribute;
detecting, by the first device, an orientation of a user when the first input is detected;
calculating a first field of view based, at least in part, on the orientation of the user;
identifying a plurality of devices connected to a network, wherein each device of the plurality of devices is associated with at least one attribute;
selecting a set of devices of the plurality of devices based, at least in part, on each device of the set of devices being associated with the first attribute;
selecting a subset of devices of the set of devices based, at least in part, on each device of the subset of devices being located within the first field of view;
identifying a first display element associated with a second device of the subset of devices; and
displaying the first display element.

2. The method of claim 1, wherein the first device is a wearable extended reality (XR) device, and the first device displays the first display element.

3. The method of claim 2, further comprising:
receiving a second input associated with the first display element; and
causing the second device to execute a command based, at least in part, on receiving the second input.

4. The method of claim 2, further comprising:
identifying a second display element associated with a third device of the subset of devices; and
displaying, by the first device, the second display element.

5. The method of claim 4, wherein the first device displays the first display element and the second display element at the same time.

6. The method of claim 5, further comprising:
receiving a second input associated with the first display element; and
causing the second device to execute a command based, at least in part, on receiving the second input.

7. The method of claim 2, further comprising:
processing the first input using a natural language processing (NLP) model to determine at least one characteristic associated with the first input, wherein the first input is a voice query comprising at least one word;
accessing a database comprising a plurality of entries, wherein each entry of the plurality of entries associates attributes with one or more characteristics;
identifying a first entry of the plurality of entries, wherein the first entry associates the at least one characteristic with the first attribute; and
determining that the first input corresponds to the first attribute based, at least in part, on identifying the first entry.

8. The method of claim 2, further comprising:
registering the plurality of devices;
identifying at least one attribute for each device of the plurality of devices; and
storing the at least one attribute for each device in a data structure.

9. The method of claim 2, further comprising:
receiving a second input associated with the first display element; and
transmitting a request to the second device, wherein the request indicates a command associated with the second input.

10. The method of claim 2, wherein the first display element corresponds to an action associated with the first attribute.

11. An apparatus comprising:
control circuitry; and
at least one memory including computer program code for one or more programs, the at least one memory and the computer program code configured to, with the control circuitry, cause the apparatus to perform at least the following:
detect a first input;
determine that the first input corresponds to a first attribute;
detect an orientation of a user when the first input is detected;
calculate a first field of view based, at least in part, on the orientation of the user;
identify a plurality of devices connected to a network, wherein each device of the plurality of devices is associated with at least one attribute;
select a set of devices of the plurality of devices based, at least in part, on each device of the set of devices being associated with the first attribute;
select a subset of devices of the set of devices based, at least in part, on each device of the subset of devices being located within the first field of view;
identify a first display element associated with a first device of the subset of devices; and
display the first display element.

12. The apparatus of claim 11, wherein the apparatus is a wearable extended reality (XR) device.

13. The apparatus of claim 12, wherein the apparatus is further caused to:
receive a second input associated with the first display element; and
cause the first device to execute a command based, at least in part, on receiving the second input.

14. The apparatus of claim 12, wherein the apparatus is further caused to:
identify a second display element associated with a second device of the subset of devices; and
display the second display element.

15. The apparatus of claim 14, wherein the apparatus displays the first display element and the second display element at the same time.

16. The apparatus of claim 15, wherein the apparatus is further caused to:
receive a second input associated with the first display element; and
causing the first device to execute a command based, at least in part, on receiving the second input.

17. The apparatus of claim 12, wherein the apparatus is further caused to:
process the first input using a natural language processing (NLP) model to determine at least one characteristic associated with the first input, wherein the first input is a voice query comprising at least one word;
access a database comprising a plurality of entries, wherein each entry of the plurality of entries associates attributes with one or more characteristics;
identify a first entry of the plurality of entries, wherein the first entry associates the at least one characteristic with the first attribute; and
determine that the first input corresponds to the first attribute based, at least in part, on identifying the first entry.

18. The apparatus of claim 12, wherein the apparatus is further caused to:
register the plurality of devices;
identify at least one attribute for each device of the plurality of devices; and
store the at least one attribute for each device in a data structure.

19. The apparatus of claim 12, wherein the apparatus is further caused to:
receive a second input associated with the first display element; and
transmit a request to the first device, wherein the request indicates a command associated with the second input.

20. The apparatus of claim 12, wherein the first display element corresponds to an action associated with the first attribute.

21-120. (canceled)
